(19) United States
(12) Patent Application Publication
(10) Pub. No.: US 2015/0321226 A1
(43) Pub. Date: Nov. 12, 2015

(54) Separating Device for a Potato Harvester

(71) Applicant: Grimme Landmaschinenfabrik GmbH & Co. KG, Damme (DE)

(72) Inventors: Franz-Josef Dettmer, Ankum (DE); Christian Döhmann, Alfhausen (DE)

(21) Appl. No.: 14/708,206

(22) Filed: May 9, 2015

(30) Foreign Application Priority Data
May 10, 2014 (DE) 10 2014 006 843.9

(51) Int. Cl. B07B 9/00; A01D 33/04; A01D 33/02

(52) U.S. Cl. CPC B07B 9/00; A01D 33/02; A01D 33/04

(57) ABSTRACT

A separating device for separating crop from a mixture with admixtures has a drop stage and a conveying device supplying the mixture to the drop stage. The mixture is falling in the drop stage and the drop stage effects loosening of the mixture. A retaining element is arranged downstream of the drop stage so as to face the mixture falling in the drop stage, wherein downstream of the retaining element the crop and the solid bodies separated from the mixture are transported farther as separated individual parts in substantially opposite conveying directions. An air stream interacts with the retaining element and exits as a discharged air stream from the retaining element. A functional unit extends substantially above the retaining element and interacts at least partially with the discharged air stream and produces one or more partial air streams. The partial air streams are controllable by the functional unit.

### BACKGROUND OF THE INVENTION

The invention relates to a potato harvesting machine (potato harvester) or a processing machine provided with a separating device for separating the crop (e.g. potatoes) from a picked-up mixture comprising admixtures such as clods, rocks, haulm or similar entrained materials. A conveying device supplies the substantially compact mixture, from where the mixture is moved into an area of at least one drop stage and can be separated. Downstream of the drop stage that is effecting loosening of the mixture, at least one retaining element is provided that is oriented so as to face the falling mixture and is interacting with the at least one air stream in such a way that at least the crop and the solid bodies can be separately conveyed, away from the retaining device, as sorted individual parts in substantially oppositely oriented conveying directions, respectively.

Different method variants are known for machines and devices for root crop treating and processing, in particular potato harvesting machines. In particular for separation of potatoes or similar crop from a picked-up soil mixture with admixtures such as clods, rocks, similar solid bodies as well as fibrous materials, different concepts of mechanical separating devices with belts and screens are used (company brochure Grimme Landmaschinenfabrik GmbH & Co. KG, Damme; “Produktprogramm” (translation: product line); GEN.00283, 08/13/5000; Erntetechnik (translation: harvesting technology); pp. 14 to 23).

For affecting the mixture that has been picked up by a potato harvesting machine, a solution according to CA 10 2012 016 057 A1 proposes that an air stream is additionally utilized which is acting in the area of a retaining element on the goods to be separated moved by a conveyor across a drop stage. This air stream is directed onto the mixture that is present in loosened form in the area of the retaining element so that, in the area of a fluidic separating bed, assistance is provided for a further activated transport of crop and solid bodies in oppositely extending conveying directions.

In a sorting and separating device according to DD 206 884 A3, the crop mixture is guided across a slide which forms a part of a multi-member conveying stretch so that at its lower end a lateral air stream can act on the falling mixture.

The invention concerns the problem to configure a potato harvesting machine, provided in the area of its conveying stretch with at least one fluidic separating device, in such a way that with minimal technical expenditure an air stream which is already effective in the system can be utilized for an additional improvement of the machine-related separating processes and, for these processes, in particular a targeted discharge of admixtures with improved energy balance as well as high efficiency is enabled.

### SUMMARY OF THE INVENTION

The invention solves this problem with a separating device of a potato harvesting machine or processing machine of the afore mentioned kind in that a discharged air stream which is discharged from the area of the retaining element is interacting at least partially with a functional unit which extends substantially above the retaining element and generates at least one machine-integrated utilizable partial air stream, wherein the at least one partial air stream is controllable at least by the functional unit. Further advantageous embodiments result from the dependent claims.

A potato harvesting machine or a processing machine with a separating device for separating crop from admixtures is disclosed in CA 2 880 593 A1. In this machine, an air stream which is acting as an additional active component on the mixture is utilized for the purpose of additional energy introduction in a separating and sorting phase which is generated at a retaining element so that in particular the discharge of solid bodies and cleaned crop is improved.

An improvement according to the invention of such a separating device now provides that, based on the generated primary air stream, the discharged air stream exiting from the area of the retaining element is at least partially utilized as an energy carrier in such a way that conveying and sorting actions occurring within the potato harvesting machine can be additionally affected.

In this context, it is provided that the discharged air stream that has been used up to now only minimally after exiting from the area of the retaining element is now interacting at least partially with a functional unit which is substantially extending above the retaining element. Beginning with the discharged air stream that is exiting from the retaining element, the discharged air stream generates now the at least one partial air stream that, in accordance with its diversion and/or deflection in the area of the functional unit, can become effective substantially variably within the machine-integrated utilization ranges.

Based on this basic concept of a “secondary use” of the discharged air energy, it is conceivable that the discharged air stream in the area upstream of and/or downstream of the functional unit can also be divided into several partial air streams. The variable configuration of the functional unit is in this context designed such that the partial air stream or the partial air streams by means of respective component groups can be manually adjusted or can be automatically controllable.

Based on the substantially vertical orientation of the discharged air stream which is exiting from the retaining element in particular above its mixing zone, the discharged air stream can be oriented with adaptable flow angles relative to the functional unit and a targeted partial air stream can then be discharged from the functional unit. It is also conceivable to additionally include or utilize discharged air stream components that are discharged laterally of the retaining element, to convey them farther, and to provide by means of the functional unit a “loss-free” flow zone.

The functional effect of the exiting discharged air stream is in particular geared at engaging separated goods in the form of “light” admixtures located on the retaining element or in its proximity. The lightweight separated goods can be moved by means of the discharged air stream in the direction of the functional unit and from here can be discharged in a targeted fashion. The functional unit in this context can also be designed such that the partial air streams containing the separated goods can be moved in variable directions.

The constructive configuration in the area of the functional unit provides that the latter is provided with at least one air baffle plate that engages the discharged air stream and the partial air streams formed therefrom. In accordance with the surrounding component groups of the machine and the existing free space, this air baffle plate is adaptable to various concepts of action of a targeted air guiding action and thus energy utilization.

In an advantageous embodiment of the machine concept it is provided that the functional unit is arranged in proximity of at least one haulm removal belt or similar conveyor for admixtures that is circulating within the machine. At least one of the partial air streams of the discharged air stream influenced by the air baffle plate can be directed toward this conveyor so that in this area a targeted influence on the system with additional cleaning action is enabled.

The conveyor which conventionally is designed as a haulm removal belt is integrated into the system such that, within the machine, the conveyor is circulating at least sectionwise above the air baffle plate. In the flow direction of the discharged air stream upstream of this upper area, the at least one air baffle plate is positioned such that the downstream end of the air baffle plate predetermines a defined direction for the at least one partial air stream. Accordingly, the partial air stream can be directed onto the circulating haulm removal belt so that air at high speed is blown through it and at least fibrous debris is removed. Conceivable in this context is also the generation of several parallel or turbulent partial air streams. Also, it is conceivable to orient the partial air stream at least sectionwise parallel to the running direction of the haulm removal belt in order to obtain an improved stripping effect.

In an expedient embodiment, by means of the air baffle plate at least the partial air stream, which is oriented onto a partial area of the return run of the haulm removal belt and is utilizable for blowing off debris from the haulm removal belt, is configured such that a high efficiency of the cleaning action is achieved with maximum blowing action.

In a complex interaction of the components of the separating process in the machine, the air deflection with the additional cleaning effect is effectively utilized for the first time. The master concept is based on the haulm removal belt that is deflected above the functional unit and is extending within the machine by means of a lower return run to a leading run which is positioned above the conveying device of the mixture. In the area upstream of the retaining element of the separating device, this leading run can engage in particular the fibrous parts of the separated goods and can convey them farther. Accordingly, these fibrous separated goods reach the area of the air baffle plate and can be blown off the haulm removal belt in a targeted fashion by means of the at least one partial air stream.

Based on the afore described concept, it is conceivable that the functional unit is formed as a whole of several air baffle plates. In this context, the air baffle plates can be arranged in a parallel stacked arrangement above each other with parallel air baffle plates. Also it is conceivable to provide a spaced-apart positioning of the air baffle plates behind each other. In any case, it is achieved that the respective partial air streams of the discharged air stream in this multi-part arrangement are discharged in a targeted or directed fashion. In this context, with appropriate adjusting possibilities in the area of the adjustable holders of the air baffle plates, the deflection direction of the air baffle plates can be varied, respectively. Different pre-adjustments by hand but also automatically adjustable actuators are conceivable.

An efficient configuration in the area of the air baffle plates provides that the discharged air stream and/or its partial air streams can be guided in the area of the air baffle plates in a direction opposite to the travel direction and/or substantially transverse thereto. This results in different discharge areas out of the machine for the separated goods to be blown off. The separated goods can thus be effectively distributed.

Based on the concept that the conveying energy contained in the partial air streams is to be used optimally, it is provided that the functional unit in the area of the upper baffle plate is provided with boundary plates arranged laterally on the baffle plate. Accordingly, by means of a substantially shielded interior undesirable air escape flows and pressure losses can be avoided. By means of the partial air streams that are in particular oriented to the rear an optimal cleaning effect is achieved.

In expanding on the afore described concept, it is provided that the functional unit in the effective area of the discharged air stream and the directed partial air streams is interacting with at least one shrouding cover. This shrouding cover which may be of a one-part or multi-part configuration is in this context at least partially foldable so that, in addition to the influence effected by the functional unit, a separated goods stream generated in its area can be deflected in a targeted fashion and, in this context, a “dust-free” deposition of admixtures onto the soil of the field adjacent or behind the machine can be realized.

The concept of the shrouding cover provides also that it is adjustable at least sectionwise to variable functional positions. Based on the system of the machine as a whole, it is provided advantageously that the shrouding cover in particular can be moved into a position of non-use which advantageously reduces the length of the machine for transport on roads.

### BRIEF DESCRIPTION OF THE DRAWING

Further details and advantageous embodiments of the invention result from the following description and the drawing in which an embodiment of the device according to the invention is illustrated.

FIG. 1 shows a side view of a separating device of the prior art.

FIG. 2 shows a partially sectioned side view of a potato harvesting machine provided with a separating device.

FIG. 3 shows a principal illustration of the system similar to FIG. 2 in a detail view.

FIG. 4 is a partially sectioned view similar to FIG. 2 with a shroud construction provided as a rearward shrouding cover.

### DESCRIPTION OF THE PREFERRED EMBODIMENTS

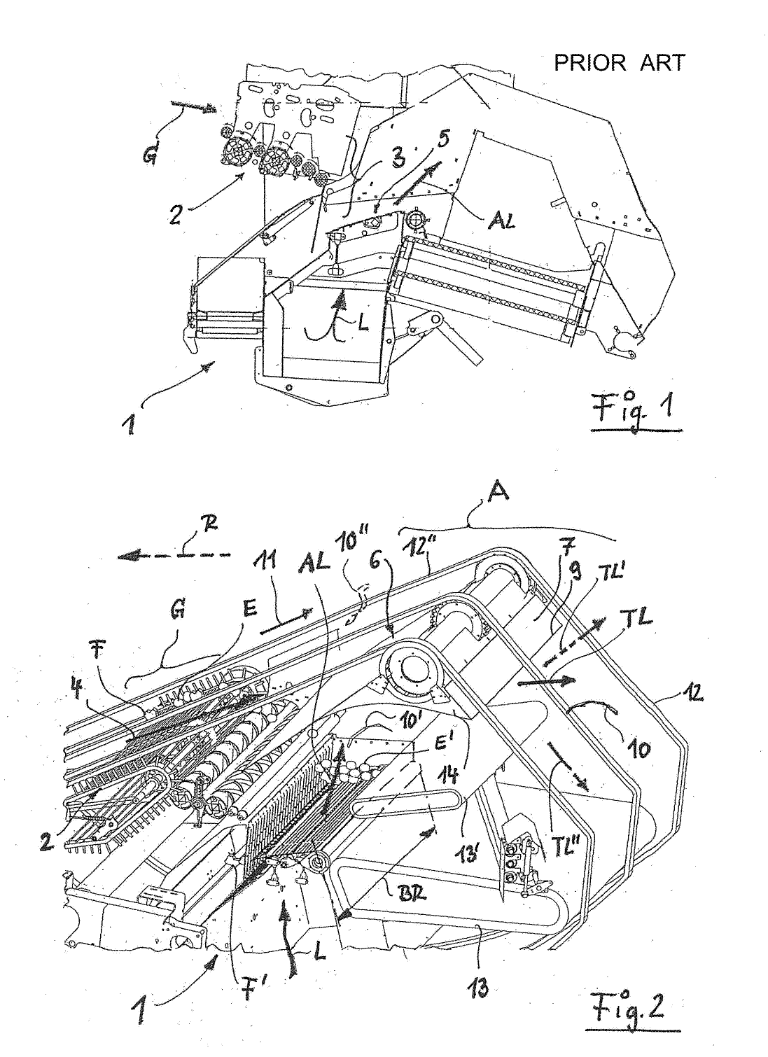

FIG. 1 illustrates a separating device of the prior art referenced as a whole by 1 which, according to the illustration of FIG. 2, is integrated into a potato harvesting machine A. In any case, this separating device 1 is provided for separating potatoes or similar crop E from a mixture G with admixtures such as clods, rocks, and similar solid bodies F. In this context, the mixture G is supplied as a conveyed stream 4 by means of a conveying device, which is referenced as a whole by 2, from a pickup area of the machine A that is not shown in detail. Following this conveying stretch, the mixture G reaches the area of a drop stage 3 (FIG. 1) from where the mixture G that is loosened more and more is moved onto a retaining element 5 in the area of the separating device 1. In this area the actual “sorting” of the important components of the mixture G is carried out wherein the crop E′ and the solid bodies F′ are separately transported farther in substantially oppositely extending conveying directions. This separation phase is enhanced or assisted by means of an air stream L produced by an external blower (not illustrated).

The concept that is improved according to the invention provides now in the area of the separating device 1 an optimized utilization of the air stream L. For this purpose it is provided that a discharged air stream AL that is exiting from the area of the retaining element 5 is at least partially interacting with a functional unit 6 that is extending substantially above the retaining element 5 and generates at least one machine-integrated utilizable partial air stream TL.

Based on the discharged air stream AL which is extending substantially across the width BR of the retaining element 5, it is provided that the air stream AL, considering the partial air stream TL, can also be divided into several partial air streams TL′, TL″ (FIG. 2). The configuration of the functional unit 6 can also be geared at dividing already the discharged air stream AL in the proximity of the retaining element 5 into several partial air streams and/or partial flow directions (not illustrated).

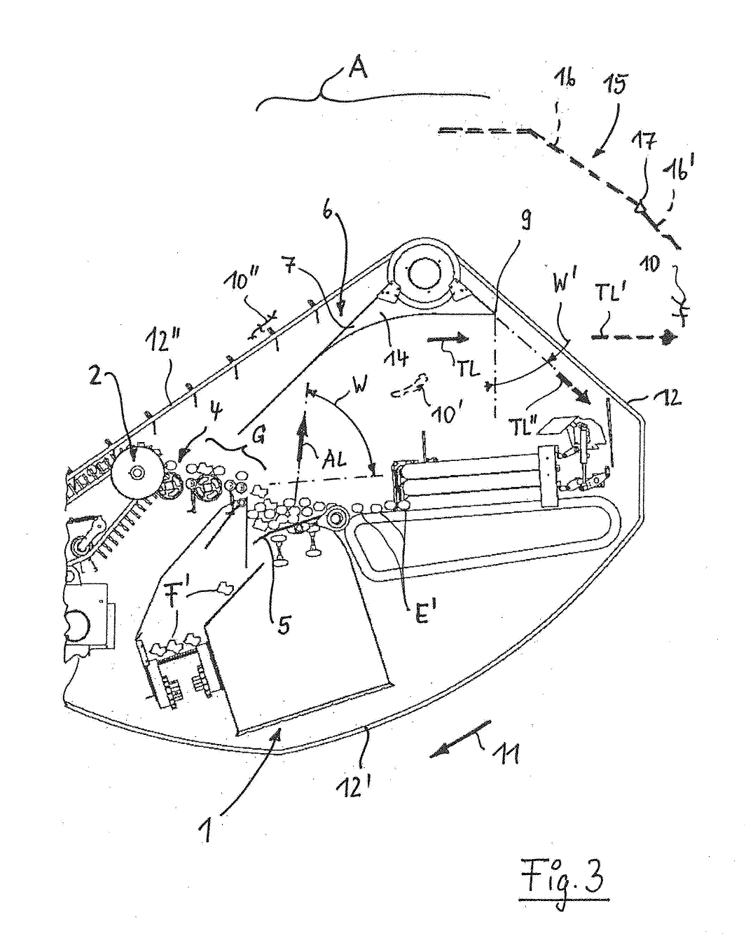

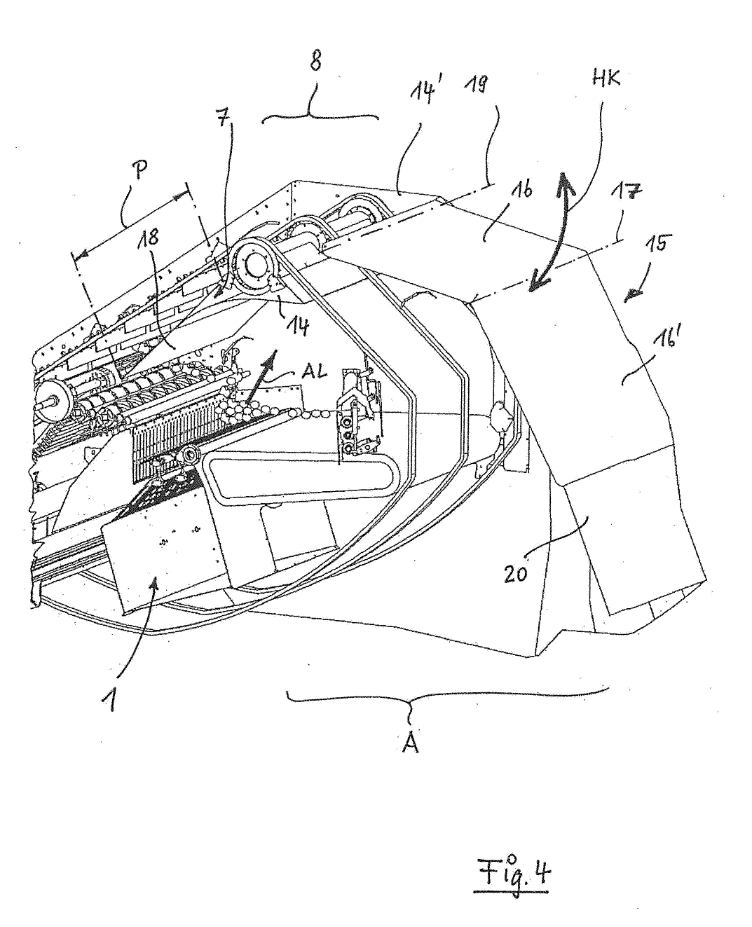

Based on the general concept of the functional unit 6 integrated into the machine A, it is provided that the functional unit 6 can be furnished with different control functions. In this context, constructive options are provided with which already the discharged air stream AL can be oriented toward the functional unit 6 with adaptable or variable flow angles (angle W, FIG. 3). This adaptation of the flow angle W is also provided variably in the area of the outflowing partial air streams TL, TL′, TL″. In FIG. 3, a variant of this flow guiding action is illustrated with angle W′.

With the concept according to the invention of the controlled discharged air stream AL, it is achieved that separated goods 10′ (FIG. 2) engaged by this air stream AL is moved in the direction of the functional unit 6 and from there can be deflected in the indicated directions of the partial air streams TL. The separated goods, for example, in the form of fibrous plant residues, haulm components or the like admixtures 10, can be moved in this context in constant or variable directions.

The comparatively simple concept of the construction in the area of the functional unit 6 provides that the functional unit 6 comprises at least one component group in the form of an air baffle plate 7 that is engaging the discharged air stream L.

Based on the concept of the machine A as a whole according to FIG. 2 and FIG. 4, it is apparent that the machine A is provided with at least one haulm removal belt or a similar conveyor 8 circulating within the machine A, wherein at least one partial air stream TL of the discharged air stream AL that is affected by the baffle plate 7 can be directed as a directed flow toward the conveyor 8. The conveyor 8 which is designed as a haulm removal belt is arranged at least partially above the air baffle plate 7 in this concept. This provides the condition that at the downstream end 9 of the air baffle plate 7 the at least one partial air stream TL can be directed as a directed flow onto the circulating conveyor (haulm removal belt) 8 and by means of the partial air streams TL′ the respective admixtures 10 in the form of fibrous parts can be carried away.

This concept with the conveyor (haulm removal belt) 8 circulating in the direction of arrow 11 provides that the air baffle plate 7 interacting with conveyor 8 produces at least the partial air stream TL′ that is directed onto a partial area of the return run 12 and is utilizable for blowing off debris from the conveyor (haulm removal belt) 8.

The conveyor (haulm removal belt) 8 which is deflected above the functional unit 6 is extending within the machine A so as to comprise a lower return run 12′ extending into a leading run 12″ (FIG. 3) that is extending above the forward conveying device 2 of the mixture G. It is thus apparent that the leading run 12″ is capable of engaging fibrous parts of the separated goods in the form of admixtures 10″ already in the area upstream of the retaining element 5 of the separating device 1 in the pickup area of the machine A; these fibrous separated goods can be blown off downstream of the air baffle plate 7 together with the parts 10, 10′ in the illustrated way from the conveyor (haulm removal belt) 8.

Independent of this optimal use of the air guiding system AL according to the invention, also other options of a targeted air guiding action, not illustrated in detail in this context, are conceivable, for example, in the area of a downstream conveying belt 13 (FIG. 2) for the crop E′. Also, the blown-off separated goods 10′ can be directed onto a transverse conveyor 13 or a similar guiding element.

The constructive configuration of the functional unit 6 provides also that the functional unit 6 can be provided with several air baffle plates. This configuration, not illustrated in detail, comprising several air baffle plates can encompass a stacked arrangement and/or a spaced-apart arrangement of components behind each other so that respective variably oriented partial air streams can be generated from the discharged air stream AL.

In the illustrated embodiment of the air guiding action, it is provided that the discharged air stream AL and/or its partial air streams TL″ can be selectively directed opposite to the travel direction R and/or substantially transverse thereto.

A further optimization of the components in the area of the functional unit 6 provides that the functional unit 6, in the area of the upper air baffle plate 7, is provided with laterally arranged boundary plates 14 (FIG. 2, FIG. 4) of different lengths and contours in addition to a deflector plate 18 which can be designed to have a variable length P. In this way a further option is proposed for providing a concentration of the discharged air stream AL by such additional guiding elements so that undesirable air escape flows in directions that are of low efficiency are avoided. From FIG. 4 it is also apparent that in the lateral area adjacent to the air baffle plate 7 respective boundary plates 14′ are provided so that the entire air guiding system can be efficiently used with a substantially closed envelope contour.

A further configuration of the system provides that the functional unit 6 in the area of the upper air baffle plate 7 is provided with an additional shrouding cover 15 (dashed illustration in FIG. 3; see also FIG. 4). In this way, the effective area of the discharged air stream AL or of the partial air streams TL′, TL″ can be additionally improved such that the controlled discharge of admixtures can be designed efficiently. In this context, in particular a substantially “dust-free” discharge of the separated goods onto the soil of the field behind the machine A is provided.

An advantageous embodiment of the system provides that the multi-part shrouding cover 15 is provided with at least two partial members 16, 16′ and in this way the shrouding cover 15 can be folded sectionwise (arrow HK, FIG. 4). For this purpose, in particular the rear one of the two partial members 16′ can be movably secured on a hinge 17. In this way, the shrouding cover 15 at least sectionwise is adjustable to variable functional positions and a dust-reducing shrouding cover is provided. For this purpose, at the rearward partial member 16′, in a configuration generally known in the art, a dust collecting sheet 20 or a similar braking element can be provided.

In an advantageous embodiment, it is also provided that the shrouding cover 15 can be moved into a position of non-use which reduces the total length of the machine A so that the system can be adjusted to optimal conditions for transport on roads. Conceivable in this context is an additional displacement of the shrouding cover 15 in the area of a support axis 19 or a folded position (not illustrated) of the partial members 16, 16′.

The specification incorporates by reference the entire disclosure of German priority document 10 2014 006 843.9 having a filing date of May 10, 2014.

While specific embodiments of the invention have been shown and described in detail to illustrate the inventive principles, it will be understood that the invention may be embodied otherwise without departing from such principles.

What is claimed is:

1. A separating device for a potato harvesting machine or a processing machine for separating a crop from a mixture with admixtures, the separating device comprising:
a drop stage;
a conveying device supplying the mixture to the drop stage, wherein the mixture is falling in the drop stage and the drop stage effects loosening of the mixture;
a retaining element arranged downstream of the drop stage so as to face the mixture falling in the drop stage, wherein downstream of the retaining element the crop and solid bodies separated from the mixture are transported farther as separated individual parts in a first conveying direction and a second conveying direction, respectively;
an air stream interacting with the retaining element exiting as a discharged air stream from the retaining element;
a functional unit extending substantially above the retaining element;
wherein the functional unit is configured to interact at least partially with the discharged air stream and to produce one or more partial air streams, wherein the one or more partial air streams are controllable by the functional unit.

2. The separating device according to claim 1, wherein the discharged air stream is directed with an adaptable flow angle toward the functional unit and the functional unit is configured to discharge the one or more partial air streams as a directed flow, respectively.

3. The separating device according to claim 1, wherein separated goods separated from the mixture are engaged by the discharged air stream, moved by the discharged air stream toward the functional unit, and discharged through the functional unit by the one or more partial air streams.

4. The separating device according to claim 4, wherein the one or more partial air streams containing the separated goods can be moved in variable directions.

5. The separating device according to claim 1, wherein the functional unit comprises at least one air baffle plate interacting with the discharged air stream.

6. The separating device according to claim 5, further comprising at least one conveyor circulating in the area of the functional unit, wherein the at least one air baffle plate produces the one or more partial air streams and the one or more partial air streams are directed toward the at least one conveyor.

7. The separating device according to claim 6, wherein the at least one conveyor is a haulm removal belt.

8. The separating device according to claim 7, wherein the haulm removal belt extends at least sectionwise above the at least one air baffle plate such that, at a downstream end of the at least one air baffle plate, the one or more partial air streams are directed onto the haulm removal belt.

9. The separating device according to claim 8, wherein the haulm removal belt comprises a return run and wherein the air baffle plate directs the one or more partial air streams onto a partial area of the return run of the haulm removal belt so as to blow separated goods separated from the mixture off the haulm removal belt.

10. The separating device according to claim 8, wherein the haulm removal belt comprises a leading run extending above the conveying device of the mixture, wherein the leading run is deflected above the functional unit into the return run, wherein the leading run in an area upstream of the retaining element engages fibrous parts of the separated goods and the fibrous parts of the separated goods are blown off downstream of the air baffle plate from the haulm removal belt by the one or more partial air streams.

11. The separating device according to claim 1, wherein the functional unit comprises several air baffle plates.

12. The separating device according to claim 11, wherein the air baffle plates are arranged parallel to each other in a stacked arrangement and discharge the one or more partial air streams in a directed flow.

13. The separating device according to claim 11, wherein the air baffle plates are spaced apart and arranged behind each other and discharge the one or more partial air streams in a directed flow.

14. The separating device according to claim 1, wherein the one or more partial air streams are guided opposite to a travel direction of the separating device and/or substantially transverse to the travel direction.

15. The separating device according to claim 1, wherein the discharged air stream is guided opposite to a travel direction of the separating device and/or substantially transverse to the travel direction.

16. The separating device according to claim 1, wherein the functional unit comprises an upper baffle plate comprising lateral boundary plates.

17. The separating device according to claim 1, further comprising a shrouding cover arranged near the functional unit in an effective area of the discharged air stream or of the one or more partial air streams.

18. The separating device according to claim 17, wherein the shrouding cover comprises one or more members.

19. The separating device according to claim 17, wherein the shrouding cover comprises at least partially foldable members.

20. The separating device according to claim 17, wherein the shrouding cover is adjustable at least sectionwise to variable functional positions.

21. The separating device according to claim 17, wherein the shrouding cover is configured to be moved into a position of non-use reducing a length of the potato harvesting machine or the processing machine.
